(19) United States
(12) Patent Application Publication
(10) Pub. No.: US 2011/0255807 A1
(43) Pub. Date: Oct. 20, 2011

(54) Woven Polymeric Bag with Pinch-Bottom Seal and Method of Making the Same

(76) Inventors: Allen Michael Shapiro, East Grand Rapids, MI (US); James W. Abel, Collierville, TN (US)

(21) Appl. No.: 12/817,079

(22) Filed: Jun. 16, 2010

Related U.S. Application Data
(63) Continuation-in-part of application No. 11/441,517, filed on May 26, 2006.

(51) Int. Cl. B65D 33/24; B65D 33/18; B65D 30/20; B31B 1/62; B31B 1/90

(52) U.S. Cl. 383/61.3; 493/264; 493/213; 383/120; 383/121

(57) ABSTRACT

A polymer bag including a layer of a woven polymer and a method of sealing the gusseted bag by utilizing plasma treatment for sealing at least a pinch bottom of the bag, and additionally, profile strips for reclosably opening and closing the top of the bag.

### CROSS-REFERENCE TO RELATED APPLICATION

The present patent application is a continuation-in-part application of U.S. patent application Ser. No. 11/441,517, filed Mar. 26, 2006, entitled Method for Closing and Sealing a Woven Polymeric Bag, which prior application is hereby incorporated herein by reference.

### BACKGROUND OF THE INVENTION

1. Field of the Invention

This invention pertains to a polypropylene woven bag with a bottom pinch seal for the containment and storage of animal feed, pet food and other similar types of contents. More particularly, the invention relates to a woven polypropylene bag with a pinch seal on the bottom of the bag and that includes one of a variety of seals for the top of the bag, including a pinch seal.

2. Description of the Prior Art

Manufacturers of plastic bags have known for some time to use adhesives to seal the bottom portion of the bag. In particular, the bottom portions of paper bags have been sealed using hot melt adhesive. As is noted in U.S. patent application Ser. No. 11/441,517, filed May 26, 2006, which is the parent of the present application, hot melt adhesives may be used to seal pinch bottom bags. However, for certain applications in which the bottom seal of the bag is severely tested by heavy weight loads, the hot melt adhesive seals sometimes fail. Similarly, use of hot melt adhesives for sealing reclosable fastener profiles to bags can be found in U.S. Pat. No. 4,341,575.

### SUMMARY OF THE INVENTION

In one aspect of the invention, a bag is formed, including a polymer outer layer and a woven polymer layer adjacent the outer layer. An intermediate layer or layers may be placed between the polymeric outer layer and woven inner layer. The bag may have a stitched closure with a drawstring for opening the bag, or alternatively, a reclosable fastener strip with or without a slider for opening and closing the strip or a top pinch seal. The folding and sealing of the bottom of the bag is accomplished by inwardly projected gusset-like folds that are sealed to form a bottom pinch seal. Preferred polymers for the construction of the bag include polypropylene and woven polypropylene.

In an additional aspect of the invention, it has been found that by pretreating the polypropylene film in selected areas with binding agents, which are defined as plasma treatment and corona treatment, for example, preferably thin air plasma jets, the surface of the polypropylene is sufficiently roughened so that the chemical bonding to adhesives and other polymers is sufficiently enhanced to provide significantly improved adhesive bonding. When pinch bottom bags having the bottom surfaces of the bag pretreated with plasma and hot melt adhesive applied thereto during the forming process of the bottom of the bag, the seal is at least 50% stronger than polypropylene bags in which only hot melt is utilized.

In another aspect of the invention, corona treatment is applied to polymer film where adhesive will be applied for sealing the bag.

In another aspect of the invention, ultrasonic waves are applied to seal the polymer film for sealing the bag.

In another aspect of that invention, reclosable fasteners are utilized to close and open the top opening of the bag for easy access to the contents of the bag.

Another aspect of the invention is its use of a reclosable fastener vertically oriented on one side at the top of the bag.

### BRIEF DESCRIPTION OF THE DRAWINGS

Embodiments are disclosed herein with reference to the accompanying drawings. In the drawings, like reference numbers indicate identical or functionally similar elements.

FIG. 1 is a flow diagram of a method for sealing a bag;

FIG. 2 is a perspective view of the rear of a bag;

FIG. 3 is a perspective view of the front of a bag;

FIG. 4 is an elevational view of one lateral side of the bag showing a slit in one crease;

FIG. 5 is an elevational view of the lateral side of the bag showing the portions to be folded grouped together;

FIG. 6 is a sectional view of the lateral side of the bag after a first rearward fold;

FIG. 7 is a sectional view of the lateral side of the bag after a second rearward fold;

FIG. 8 is an elevational view of the rear side of the bag after the first rearward fold showing the treated surface of the bag and application of adhesive;

FIG. 9 is a plan view of a sealed rear wall of the bag showing a second rearward fold of one embodiment of the invention;

FIG. 10 is an elevational view of one embodiment of the invention showing multiple plies of a bag;

FIG. 11 is an elevational view of the application of an adhesive on the bag of one embodiment of the invention;

FIG. 12 is a sectional view of the second rearward folding of the bag;

FIG. 13 is a view of a plurality of jets applying plasma treatment to the surface of a sheet of polymer, wherein folds of the tub-like bag structure are not shown;

FIG. 14 is a view of dual jets applying plasma treatment to the surface of a sheet of polymer;

FIG. 15 is an elevational view of a cutter for forming a slit in a ply of the bag;

FIG. 16 is a schematic view of a portion of a production line showing cut tube-like bags of polymer being folded, applying plasma treatment and adhesive and showing the first and second rearward folds, while also showing ultrasonic vibration for sealing tube-like bags if plasma or corona treatments are not utilized;

FIG. 17 is a view of the top closure of a bag showing a pinch seal on the top closure of one embodiment of the bag of the invention;

FIG. 18 is a view of the top closure including a drawstring;

FIG. 19 is a view of the bag of one embodiment of the present invention having a top closure including reclosable zipper;

FIG. 20 is a sectional view of the strip fasteners of the reclosable zipper of one embodiment of the present invention;

FIG. 21 is a view of the slider for opening and closing the zipper shown in FIG. 2 of one embodiment of the invention;

FIG. 22 is a view of a vertically oriented zipper on one side of the top of the bag for opening and closing the bag of one embodiment of the present invention;

FIG. 23 is a bar graph showing superior results of plastic bonding using plasma treatment versus no plasma treatment for polypropylene in a 2K epoxy system with curing at 80° C. for two hours;

FIG. 24 is a side view of an apparatus for applying corona treatment to the surface of the bag of one embodiment of the invention;

FIG. 25 is an elevational view of an apparatus for applying ultrasonic waves to the surface of a bag in an embodiment of the invention;

FIG. 26 is an end of the vibrator of FIG. 25; and

FIG. 27 is a side view of the end of vibrator shown in FIG. 26 impinging polypropylene film.

### DETAILED DESCRIPTION OF THE INVENTION

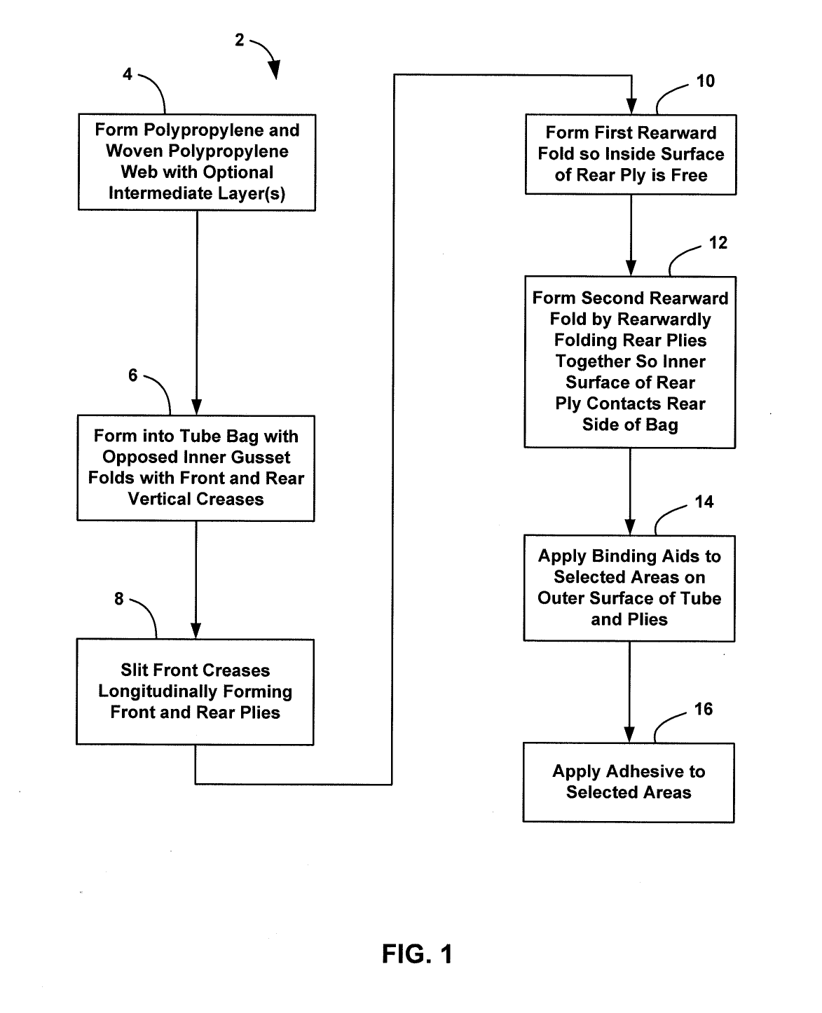

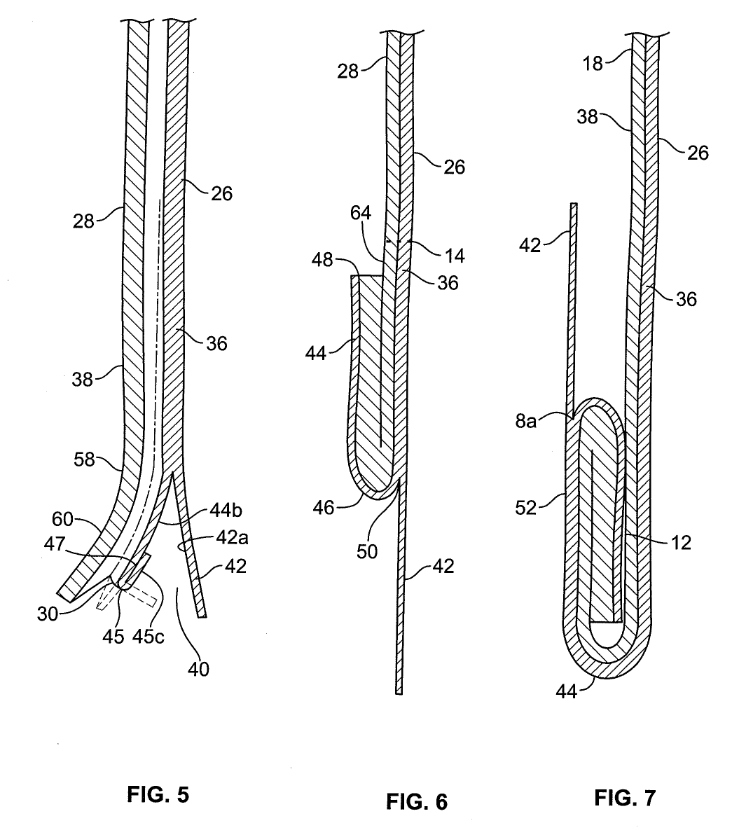

The various embodiments of the present invention and their advantages are best understood by referring to FIGS. 1 through 27 of the drawings. The elements of the drawings are not necessarily to scale, emphasis instead being placed upon clearly illustrating the principles of the invention. Throughout the drawings, like numerals are used for like and corresponding parts of the various drawings.

The drawings represent and illustrate examples of the various embodiments of the invention, and not a limitation thereof. It will be apparent to those skilled in the art that various modifications and variations can be made in the present inventions without departing from the scope and spirit of the invention as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present invention covers such modifications as come within the scope of the features and their equivalents.

Furthermore, any reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

Preferred embodiments of the invention include a flexible polymer bag for transporting and storing granular material with an improved pinch-bottom closure. The pinch-bottom closure provides strength and durability to the bag so that polymer film can be used for making the bag. The bag preferably contains a polymer outer layer, for example, polypropylene, and a woven polymer layer, for example, woven polypropylene adjacent the outer layer to provide strength to the bag. Further, the bag may optionally contain an intermediate extruded layer and other layers for convenience. However, the polymer layer and woven polymer layer in combination with the pinch bottom produces an improved bag and is a preferred embodiment.

Binding agents are defined as treatments to the surface of the polymer film which enhances the surface for improved bonding or acceptance of an adhesive for bonding with a second film. These agents include plasma treatment and corona treatment. Ultrasonic bonding is considered a binding agent even though it typically is not used with an adhesive. FIG. 1 describes the process flow 2 for generally preparing a preferred embodiment, a polypropylene and woven polypropylene bag with a pinch-seal bottom closure. In step 4, a sheet of polypropylene and woven polypropylene are formed together creating a tube or tube-like structure. An extruded intermediate layer between the polypropylene and woven polypropylene layer is optional. The extruded intermediate layer may be one or more layers of polyethylene, a blend of polypropylene and woven polypropylene, or other polymer. The intermediate layer supplies support for the film. The tube is folded to form a bag with gussets with front and rear vertical creases. While moving on a conveyor, the tube is optionally subjected to a binding aid, such as, for example, plasma treatment or corona treatment for preparing the surface of the polymer film for receiving an adhesive in one or more areas, primarily the back wall near the bottom of the bag and the top of the bag near the opening in areas that will receive a conventional or hot melt adhesive. Binding aids are preferably applied in subsequent steps of the method. Application of a plasma treatment disrupts the surface of the film and makes a surface readily receivable for the adhesive. A slit is made in an outer crease adjacent to the side of the bag that will be in the front of the bag in step 8. The slit could be made in either the front or rear sidewall. The slit creates the front ply and a first rearward fold is creased so that the inside surface of the rear ply is free as shown in step 10. In step 12, a second rearward fold is made by folding rear plies together so inner surface of rear ply contacts rear side of bag. In step 14, a binding aid is applied to the second rearward fold and higher upon the rear outer surface of the bag wall. The second rearward fold is folded rearwardly so that the rear plies come together. In this manner, the inner surface of rear ply contacts the rear side of the bag in the area that has been pretreated by a binding aid. In step 16, hot melt adhesive or conventional adhesive is applied to the area that has been pretreated by the plasma treatment or corona treatment. The bag is sealed by folding the rearward ply onto the area containing the adhesive.

The top of the bag may be closed by conventional means, for example, by folding the top edge of the bag and apply an adhesive to the folded portion facing the wall of the bag and the area of the wall of the bag contacting the fold. A pull string may be used to open the bag. The bottom seal, however, is closed by a pinch seal. Alternative seals for the top of the bag also include the use of reclosable seal with or without a slider placed on the inside wall of the bag below conventional sealing means at the very top of the bag. The reclosable seal inside the walls of the bag provides additional protection for freshness of contents, which typically may be animal food or other edible food product.

A pinch seal may also be used for sealing the top of the bag. The binding aids, preferably plasma treatment and corona treatment, are used with the adhesive, preferably a hot melt adhesive for sealing the top of the bag. Ultrasonic sealing may also be used to seal the top of the bag with or without a pinch seal and with or without adhesive.

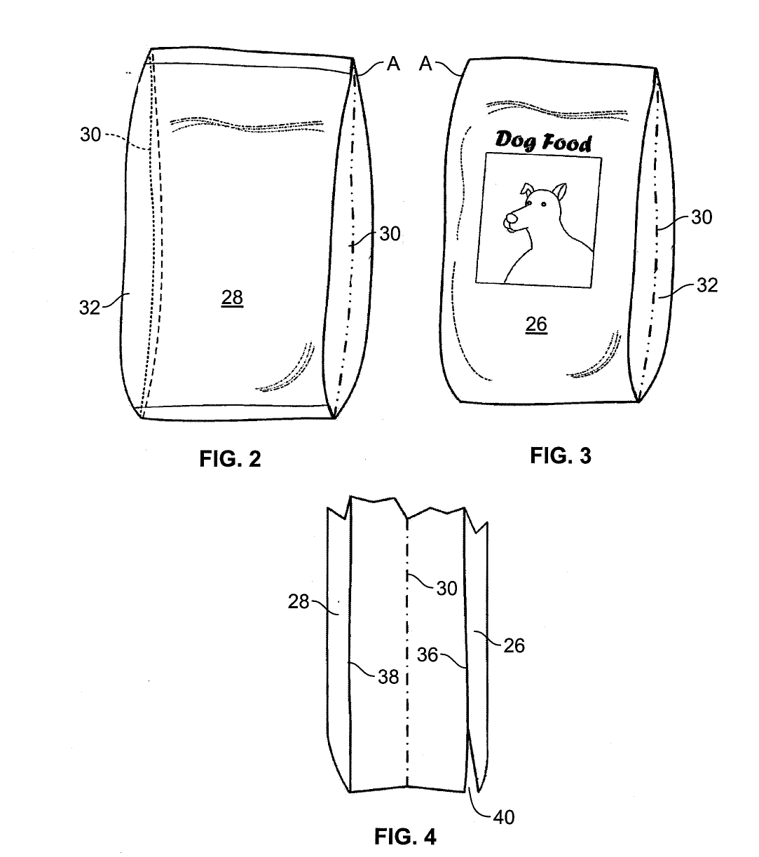

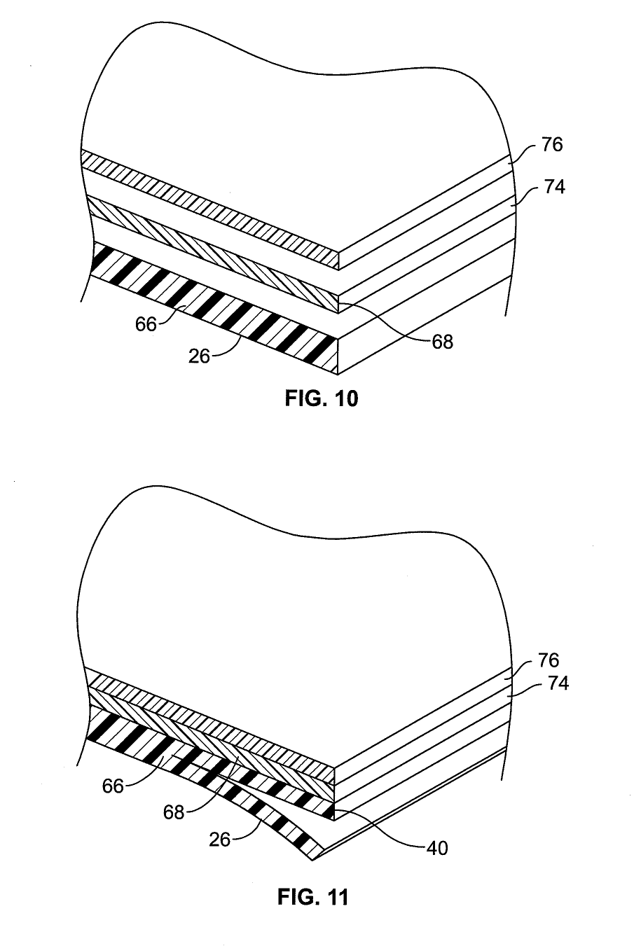

A more detailed description of the method and bag is shown in FIGS. 2 and 3 where a bag A of the type often used for animal feed or similar types of contents is shown. Bag A is made from a durable, flexible material suitable for such containment and storage of such material. One nonlimiting example of such a material is a polymer, particularly a polyolefin, preferably polypropylene, and further, woven polypropylene. These polymers can be blended in combination or used in separate, distinct sheets. Other examples include polyethylene and blends of polypropylene and polyethylene and separate layers of polymers, and other intermediate extrusion layers can be utilized with the separate woven polypropylene layer and the propylene outer layer. Bag A is formed from a tube-like structure which is cut to size. Alternatively it is formed from sheets that are confined to form a tube-like structure. One end is then closed and sealed, the bag is filled, and the opposing end is then sealed. For orientational reference, bag A includes a front side 26, and an opposing rear side 28. The front side 26 may be considered the side on which prominent displays of labeling comprising, for example, graphic designs, trademarks, and the like, a notional example of which is represented in FIG. 3. For storage purposes when the bag is empty, bag A is collapsible, having a pair of opposing inwardly projecting gusset-type folds 30 formed at the lateral sides 32, 34 of the bag. FIG. 4 illustrates an end portion of an unclosed bag A, viewed from the perspective of a gusset fold 30, where two outer creases 36, 38 forming a gusset fold 30 are referenced. FIGS. 4-7 do not show all the plies of the bag in order to facilitate the understanding of an embodiment of the invention. FIGS. 10-12 show representative partial views of the plies of an embodiment of the invention.

A slit 40 is made in an outer crease 36, preferably the outer crease adjacent the side of bag A that will be the front 26 of the bag. The slit 40 then creates a forward ply 42 and a rear ply 44. A secondary fold 44a is made with tip 45 of rear ply 44. Inside panel 47 of tip 45 is folded against area 44b of rear ply 44. Outside panel 45c is folded against rear ply 44. An adhesive is optionally required for placement on the rear ply 42 at inside 42a at area 44b so that inside panel 47 can be sealed to rear ply 44. Further adhesive can also be applied to outside panel 45c so it can seal to inside 42a of slit 42. Inside 42a can also have adhesive applied. Adhesive may also be applied in various locations on rear ply 44. All of the foregoing areas, preferably outside panel 45c, inside panel 47, inside 42a of slit 42 are treated with a binding agent, either plasma treatment or corona treatment, before application of an adhesive, including a hot melt adhesive. The forward ply 42 is kept in place while a first rearward fold 46 (FIG. 6) is formed by folding the rear ply 44 along to create rear fold 48. First rearward fold 46 is creased roughly at the vertex 50 of slit 40. A second rearward fold 52 (FIG. 7) is created by folding the entire bag A rearward where it is creased approximately at or above the level reached by the ends of the plies 42 after the first rearward fold. Examples of pinch bottom bags, apparatuses, and methods of manufacturing pinch bottom bags are seen in U.S. Pat. Nos. 6,623,162; 6,599,016; 6,367,976; 6,328,471; 5,791,485; 5,553,943; 5,474,383; 5,021,209; 4,610,651; 4,567,987; 4,550,442; 4,515,273; and 4,344,558.

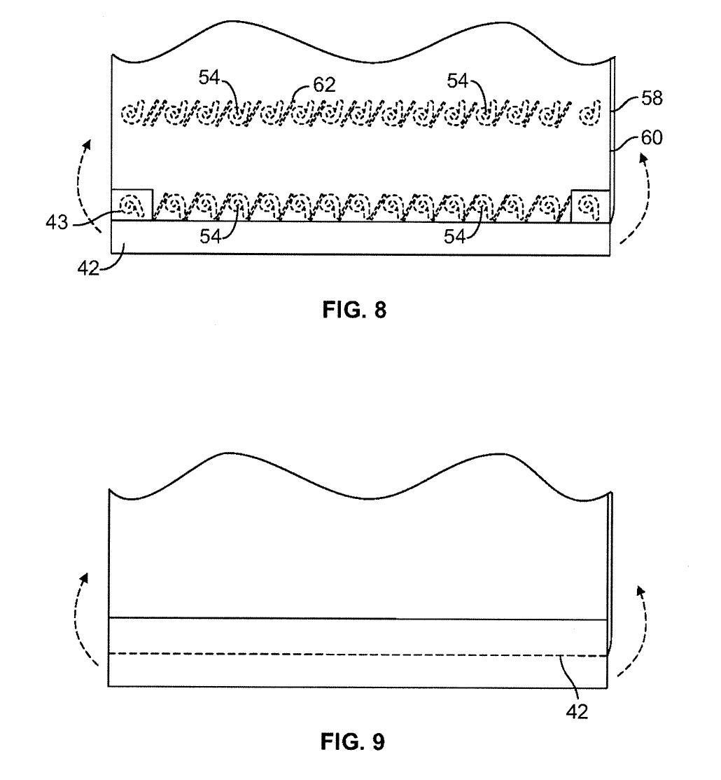

Referring to FIGS. 8 and 9, means for securing the fold is illustrated in FIG. 8 where after the first rearward fold 46, adhesive 54 is deposited on the inner surface 44b of rearward ply 44. However, before the deposition of the adhesive 54 which may or may not be a hot melt adhesive on first portion 58 of rear side wall 28 that will contact a second portion 60 of rear side wall 28 when rear ply 44 is folded, the inner surface 42a of ply 42 is preferably treated by a binding agent, for example, plasma treatment to clean the surface at an atomic level, thereby removing contaminants such as dust, moisture, etc. This treatment also increases the surface tension by activating the polymer structure and improving the wettability of the polymer. It also creates improved chemical bonding for better coating and bonding of substances applied to the polymer substrate. In addition, the treatment removes electrostatic charges. The treatment also applied to second portion 60 and first portion 58 of side wall. In the area treated, the actual surface is increased by a large degree, possibly up to 30%. In FIG. 8, the treated area is shown by slashed lines 62 with the adhesive 54 overlaying the treated area on the inner surface 56 of rearward ply 44. This treatment is called “plasma treatment” and is explained in greater detail hereinafter. Other binding and treatment includes corona treatment, which can be applied onto the same areas before the application of an adhesive. The binding agents and adhesives may also be applied in other areas previously described, for example, inside panel 47 of tip 45, outside panel 45c, area 44b of rear ply 44, etc. Gusset 43 is also shown. Further, ultrasonic treatment, in another embodiment can be applied in the same areas, with or without adhesive.

Adhesive 54 may be any suitable adhesive for securing or bonding the material to itself. By way of nonlimiting example, adhesive 54 is a hot melt adhesive known to those skilled in the relevant arts. In another embodiment, adhesive 54 is also deposited upon the rear surface 28 of the bag A within the area at which the inner surface 44b, 42a of plies 44 and 42 contact it.

Additionally, such as shown in FIG. 11, embodiments of a bag and/or bag closure can include the adhesive components of rosin ester and ethylene vinyl acetate. The hot melt adhesive can be supplied, for example, as Product No. 70-4467 from National Starch and Chemical Company, 10 Finderne Avenue, Bridgewater, N.J. 08807. Alternatively, for example, the adhesive can further include a component selected from the group consisting of: styrene-isoprene-styrene copolymers, styrene-butadiene-styrene copolymers, ethylene ethyl acrylate copolymers, polyurethane reactive adhesives, tackifiers, waxes, paraffin, antioxidants, plasticizers, plant sterols, terpene resins, polyterpene resins, turpentines, hydrocarbon resins, resin acids, fatty acids, polymerized rosins, and polyamide adhesives.

Within the adhesives industry hot melt adhesives are known to have good performance and usage benefits, as understood by those skilled in the art. Hot melt adhesives are solvent-free adhesives, that are characteristically solid at temperatures below 180° F., are low viscosity fluids above 180° F., and rapidly set upon cooling. The development of hot melt adhesive technology stemmed from the previous use of molten wax for bonding. Hot melt adhesives are used in a variety of manufacturing processes. There are a number of hot melt adhesives in use, with the most common being those used for hot melt pressure sensitive adhesive applications: ethylene vinyl acetate (EVA) copolymers, compatible with paraffin, the original hot melt; styrene-isoprene-styrene (SIS) copolymers; styrene-butadiene-styrene (SBS) copolymers; ethylene ethyl acrylate copolymers (EEA); and polyurethane reactive (PUR).

FIG. 9 depicts the completed folded closure Inner surface 44b of rearward ply 44 is bonded to rear surface 28 of bag A at second portion 60. Front ply 42 of front side 24 extends roughly vertically with respect to the bag, beyond the crease 64 of first rearward fold 46 and inner surface 42a is bonded to first portion 58 of rear side 28. FIG. 3 shows an exemplary bag A from the front perspective where it is apparent that an observer cannot see any seams, seals, or closures, thus presenting a more aesthetically pleasing package to the customer.

FIG. 10 is an elevational view of a partial section of the side of one embodiment of the present invention. Polypropylene layer 66 is the outside layer of the bag comprising the front 26 and rear 28 plies of the bag. Inside of polypropylene layer 66 is woven polypropylene layer 74. Note cross-hatchings 70 on woven polypropylene layer 76. Optionally, an intermediate or extrusion layer 68 may be adjacent woven polypropylene layer 76. Intermediate layer 68 with end 74 may be paper, polyethylene and blends of polyethylene and polypropylene. Woven polypropylene layer 76 provides strength to the outer layer, polypropylene layer 66.

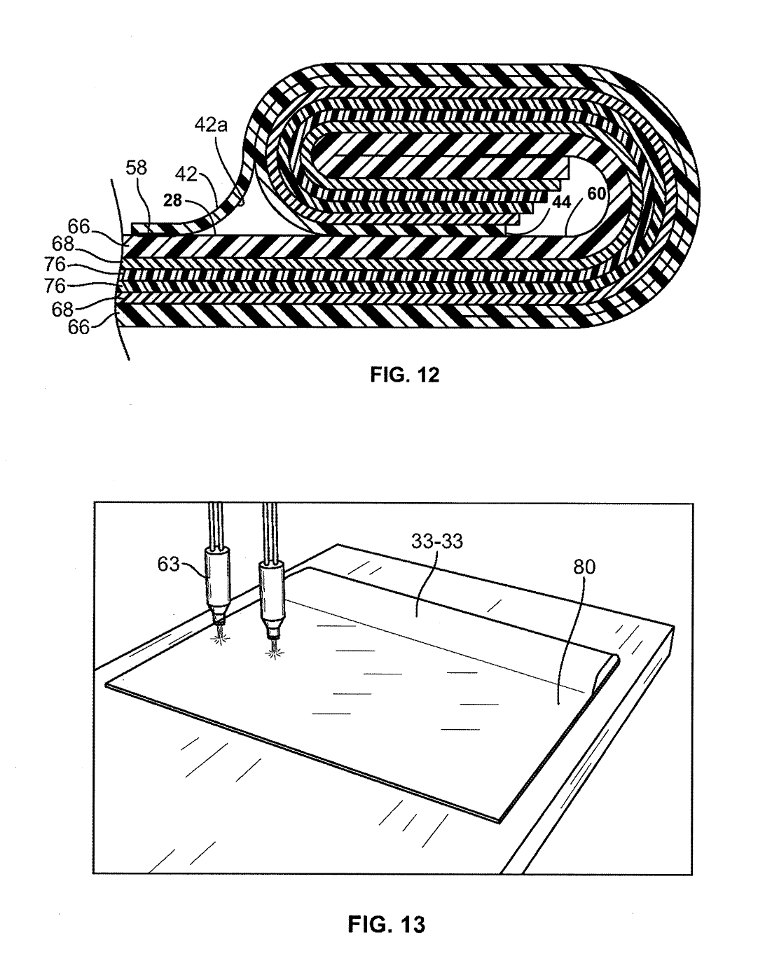

In FIGS. 11-12, a section of a multilayer polymer material that comprises bag A is shown with the individual layers of the bag showing slit 40. In FIG. 12, the front side 26 is split showing forward ply 42 contacting first portion 58 of rear side 28 folding over multiple layers of the bag. Rear ply 44 is shown contacting second portion 60 of second rear side 28. This is more specific representation than shown in FIGS. 6 and 7. Polypropylene layer 66, intermediate layer 68, and woven polypropylene layer 76 are shown.

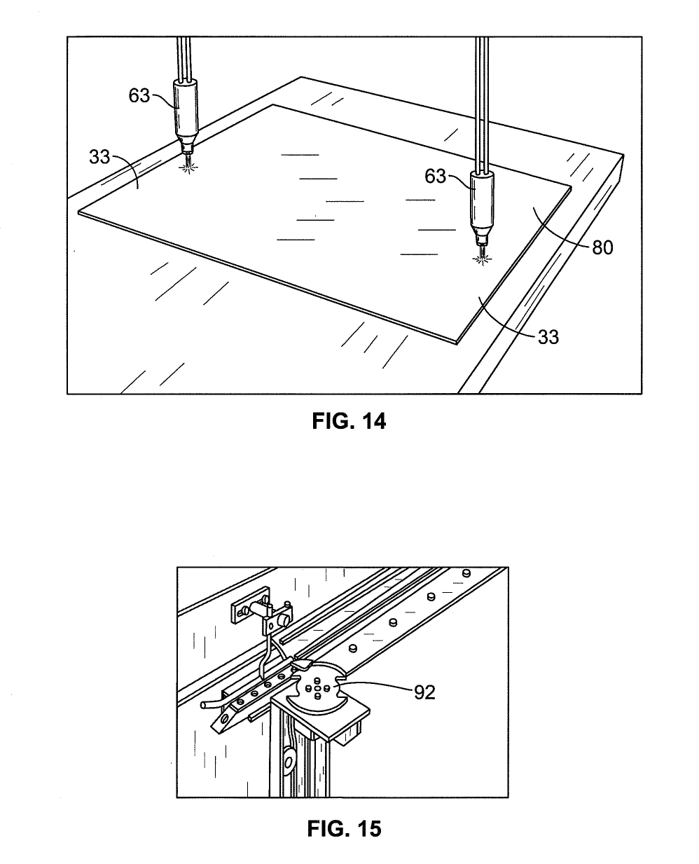

As seen in FIG. 14 of the drawings, in an alternative embodiment of the invention, a web or sheets of polymer material 80 may be pretreated using a single plasma jet or multiple plasma jets 63 in selected areas 33-33 as shown in FIG. 15 the plasma jets clean and prepare the surface of the polypropylene material for binding with an adhesive to another surface following such treatment, an adhesive or hot melt adhesive applied in the selected areas which may be subsequently fabricated into the bag. The two plasma jets provide sealing surface on both the top opening and bottom of the bag. The two plasma jets provide sealing surface on both the top opening and bottom of the bag. The resulting bags have an improved seal strength in the area where the plasma has been applied prior to the application of an adhesive. In FIG. 13, jets 63 are shown on one side of the tube-like polymer material 80 for applying binding aids to, in theory, inner surface 42a, panel 45c, panel 47, and areas 60 and 58 of wall 28. The two jets can be aligned as needed for application of the binding aids.

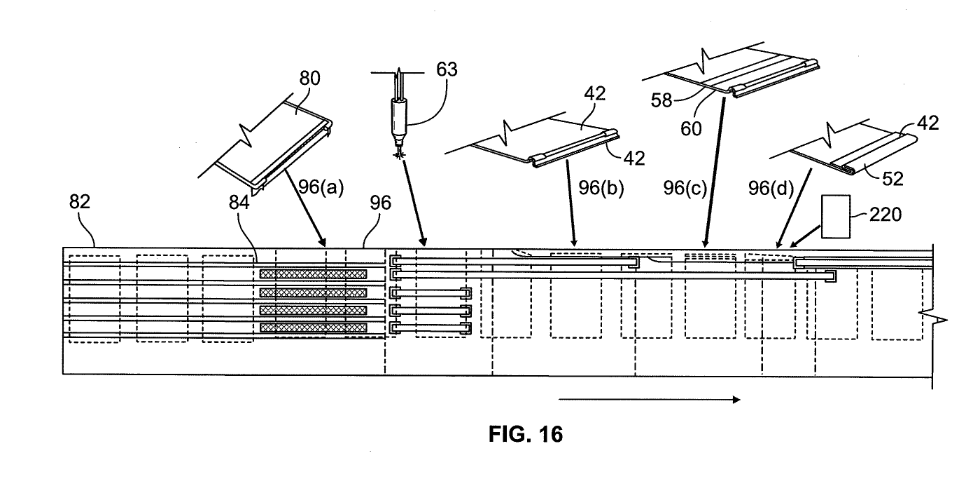

As seen in FIG. 16 of the drawings, like precut polypropylene tube-like material structures 80 are disposed on a conveyor 82 in process line and are moved through a series of roller assemblies 84 as shown in FIG. 16 wherein cutter blade assembly 90 slits front side 26. if a pinch seal is to be formed on the top opening of the bag, a cutter blade assembly is used to make a slit there. Above said web of polypropylene material is one or more plasma jets 63 which are operated on rear side 28 of bag A and other areas as previously noted, which may be sealed by various binding aids including plasma or corona treatment, and ultrasonic treatment forming conventional seals or pinch seals for selectively treating portions 33-33 of the polypropylene material 80. The slit front side 28 of bag A is shown in process 96 at station 96(a). Forward ply 42 is straightened at station 96(b). A binding aid, for example, plasma treatment or corona treatment is applied to second portion 60 of rear side 28 to prepare the ply 42 for improved binding with the addition of an adhesive. The binding aid end adhesive can be applied at multiple locations. Corona treatment 310, when utilized, is applied here. At station 96(c) adhesive 54 is applied. If ultrasonic vibration is used, vibrator 220 is utilized here and adhesive 56 is optional. Station 96(d) manipulates first 46 and second 52 rearward folds in place. Bag A is then filled with contents or stored in folded position by the collapsing of gussets 30 in an area of the process line not shown. Selected area 33-33 may correspond to first portion 60 and second portion 58 of rear side 28. This is the pretreatment of the binding aids.

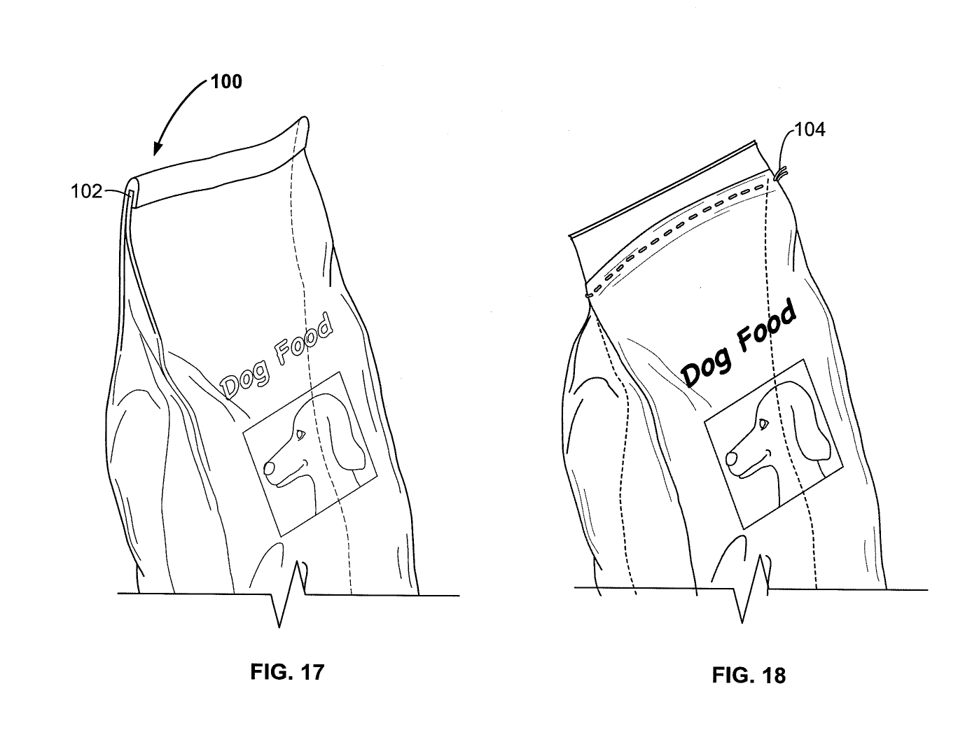

As seen in FIG. 16, 96(d) of the drawings, when the bag is slit along its bottom and back side 28 first and second portions 60 and 58 are treated by binding and adhesive the pretreated area is then compressed against the back side 28 of the bottom of the bag so as to form a strong pinch seal. Inner surface 43 of forward ply 42 is also subjected to pretreatment and application of an adhesive. A pinch seal top 100 is sealed by pinch seal in 102 in FIG. 17. This process can be applied to the top 100 of the bag for closing the opening separately or simultaneously for forming a pinch seal on the bottom of the bag.

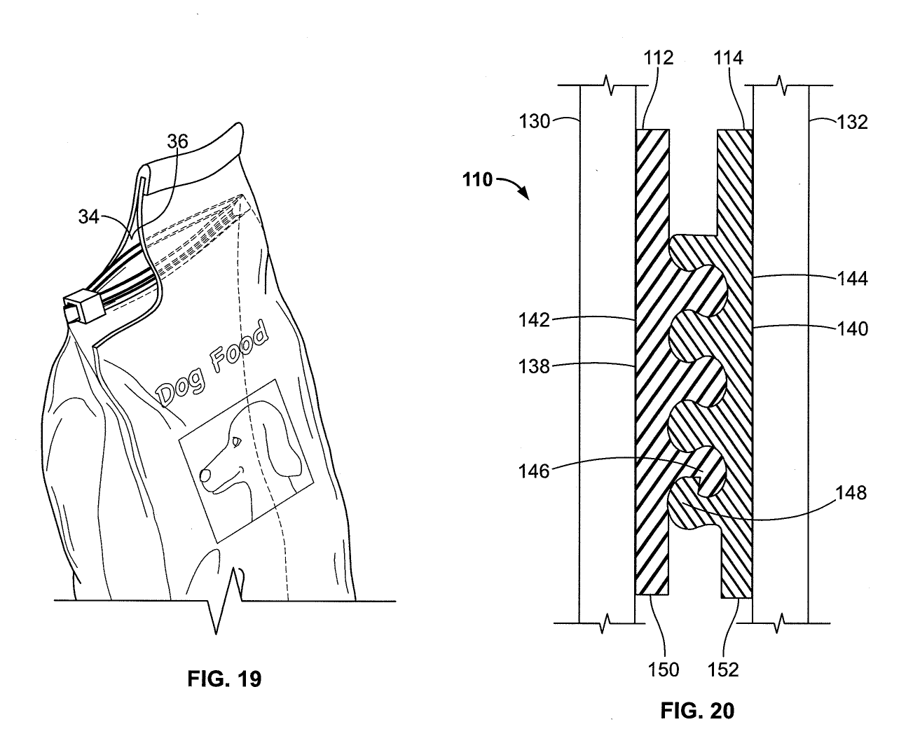

In one embodiment, shown in FIGS. 18-20, bag A includes a conventional drawstring opening 104 so the contents can be removed from the bag. In another embodiment shown in FIGS. 19-22, a continuous, profile, elongated reclosable fastener 110 is utilized for opening and closing bag A. The fastener 110 includes a first continuous elongated profile strip 112 and a second continuous elongated profile strip 114. The fastener 110 is readily secured to the inner surfaces of bag A without entrapment of air between the fastener elements and bag A. The profile strips 112, 114 are affixed to the upper portions of the inner surfaces 130, 132 of wall panels 134, 136 to close and seal the bag A from the exterior environment. Preferably, the profile strips 112, 114 are sealed on their rear surfaces 138, 140 to inner surfaces 142, 144 by means of heat sealing. The segments 150, 15 distal to profile strips 112, 114 act as pull flanges for opening the fastener assembly 110.

The first continuous elongated profile strip 112 and the second continuous elongated profile strip 114 are configured and arranged to provide a vacuum-tight seal upon interconnection thereof. The vacuum-tight seal provides the function of keeping foreign material including bacteria, molds, and viruses from entering bag A. Further, this seal stores any bacteria or other microbes inside the contents of the pouch of oxygen, thus destroying the ability to replicate. Therefore, the risk of contamination of the bag's contents is greatly reduced. Additionally, the vacuum-tight seal provides resistance to inadvertent opening of the seal due to external pressure on bag A or due to internal pressure from within bag A.

Reclosable fastener 110 has been found to provide a durable vacuum-tight seal. In FIG. 20, fastener 110 includes first continuous elongated profile strip 112 and second continuous elongated profile strip 114, each having at least one or two hooks 146, 148 thereon. First continuous elongated profile strip 112 has one hook 146; second continuous elongated profile strip 114 has one hook 148 thereon. While only one pair of hooks 146, 148 constructed and arranged on the profile strips 112, 114 in the embodiment shown in FIG. 20, it is appreciated that a greater or lesser number of hooks can be used as desired, with a corresponding increase/decrease in the width of strips 112, 114.

In another embodiment as shown in FIG. 21, bag A may include a slider 60 mounted on the strips 112, 114 and moveable in one direction 62 longitudinally of the strips 112, 114 to progressively separate rib 64 from the groove 66 to open the bag A. Slider 60, being moveable in the opposite direction 68 progressively returns the rib 64 portion to retain condition in the groove 66 to close the bag. The slider 60 further has a separator (not shown) situated therein having a proximal portion attached to the top of the slider 60 and extending downwardly therefrom.

Reclosable fastener 110 is attached to the inner wall of the bag A by an adhesive with or without the use of binding aids, plasma treatment, corona treatment, and by ultrasonic scaling.

The separator not shown has a tip constructed and arranged, i.e., positioned and sized, to facilitate selective separation of the rib 64 from the groove 66. The separator is preferably integrally formed with the slider and is made of one homogeneous unit of plastic. It may be constructed of polyethylene, polypropylene, polycarbonate, polystyrene, acryl nitryl, butyldirene styrene, or other commonly formed injection-molded plastic pieces.

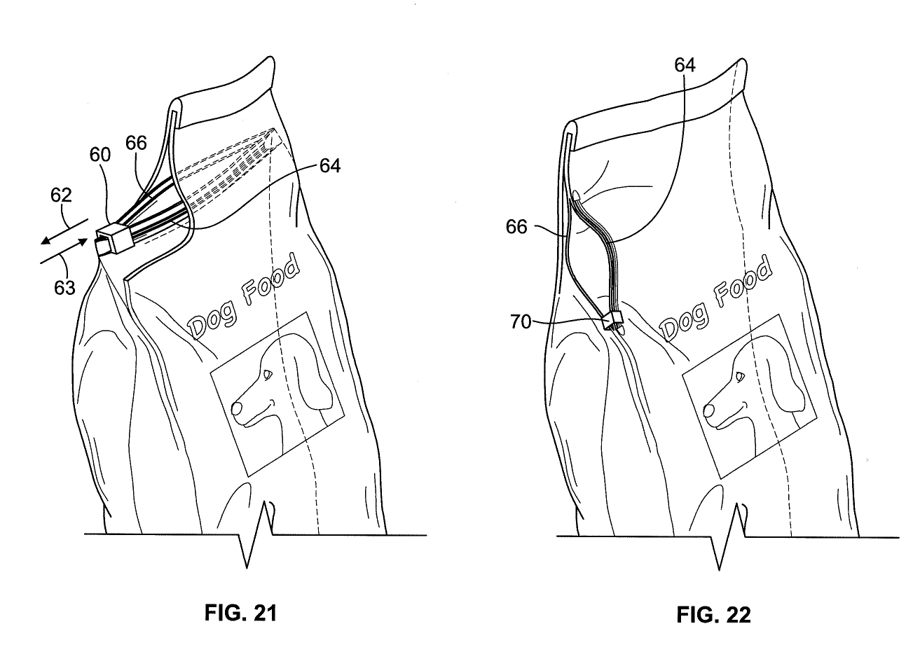

FIG. 22 illustrates reclosable fastener 110 placed on the side of bag A at the top of the bag with slider 60. The placement of the fastener 110 in this location allows dry, particulate material or the like to be poured from the bag.

Another method of obtaining sufficient adhesion on plastic film, or polypropylene, especially pretreatment of the film before the adhesion is applied, is to optimize the wetting and adhesion process. One method of accomplishing this result is the use of a high frequency electric discharge towards the film surface, for example, corona treatment. The result is an improvement of the chemical connection (dyne/cm) between the molecules in the plastic film and the applied liquid. The corona surface treatment does not reduce or change the strength of the film nor will it change the appearance of the film. Information for using corona surface treatment on plastic film is found in many references including U.S. Pat. No. 7,074,476 which is incorporated by reference.

The effectiveness of the corona treatment depends on the specific film being used. There are no limits with regard to the materials that can be corona treated. However, the required intensity of treatment (watt/min/m2) may vary significantly. The treatment level can be calculated by using the following formula:

Power(watt)=T×S×W×M
P=Total Power (Watt) required
T=Number of Sides to Treat (single/double sided)
S=Line Speed (in meters per minute)
W=Film Width (in meters)
M=Material Factor (required watt per square meter per minute)

The exact value is best determined by testing a sample of the actual film that is used for the specific application.

The corona treatment can be effected by passing the film 300 between an electrode and a stainless steel plate in a corona treating station. The electrode may have a width which corresponds to the width of the zone 33-33 so that only the zone 33-33 of the film receives the treatment. The flexible film may travel at a lengthwise direction through the corona treating station. The amount of corona treatment received by the zone 33-33 is determined by the length of the electrode, the traveling speed of the flexible carrier or film between the electrode and the plate, and the amount of the electric potential generated between the electrode and plate.

FIG. 24 schematically illustrates the corona treatment device 310. Two electrodes, 312 and 314, arranged in series, each have a length of about 6 inches and a width (perpendicular to the page) of about 2.5 inches. Alternatively, a higher number of electrodes can be arranged in series, or one electrode can be used. A steel plate 316 is below the electrodes, defining an air space 318 between the electrodes and the plate. The film 300 passes between the plate and electrodes in a direction of arrow 318. If each electrode 312 and 314 is six inches long, the film 300 is exposed to a corona treatment length of 12 inches.

In order for the corona treatment to impart a durable surface oxidation to the zone 33-33, which does not disappear over time, it is desired to treat the zone 33-33 with a very high watt density. The watt density may range from about 20-200 watts/ft.²/min., and is suitably about 30-150 watts/ft.²/min., particularly about 40-100 watts/ft.²/min.

Using the corona treatment device 310 described above, the desired watt density in zone 33-33 of a 15-mil thick film can be obtained using an air gap of 50-200 mils, suitably 60-150 mils, between the steel plate 316 and the electrodes 312 and 314. The zone 318 where the film is passed between the plate and electrodes at a speed of up to about 350 ft/min., resulting in a corona treatment residence time of at least about 0.30 seconds. To achieve the desired watt density of 400-100 watts/ft.²/min. under these conditions, the corona treatment device 310 should operate using an electric power of 1.5-1.8 kilowatts. This amount of power creates an electric potential which converts the air in the gap 318 to disassociate oxygen and nitrogen atoms, some of which react with the surface of the film. Film of different thicknesses can have the air gap adjusted accordingly, as well as the residence time. The speed is approaching a maximum and can be adjusted accordingly. The watt density can power can also be adjusted according, for example, to film having a smaller thickness that would require lower watt density and power.

Alternatively, the selective energy treatment of zone 33-33 may be selective plasma treatment. As described previously, in a typical plasma treating process, plasma is created by a supply energy in the form of radio frequency electromagnetic radiation to ionize a process gas which can be oxygen, nitrogen, argon, helium, or combinations thereof, to name a few. The plasma includes electrons, ions, and other energetic metastable species. The energies of individual plasma particles may range from about 3-20 electron volts. When these energetic particles contact a surface in zone 33-33 of film 300, the surface becomes energized via ionization, or chemical reaction which is typically oxidation.

As best seen in FIGS. 8, 9 and 13-16 of the drawings, the plasma jets are utilized to pretreat polypropylene in selected areas so that a pinch bag closure and reclosable fastener strip can be sealed on the polymer, whether it be on the top or bottom. Resulting seals between fastener profiles and bags is stronger than conventional heat sealing and may be used for heavier products in accordance with the present invention.

In a preferred embodiment, the plasma jets for treating the polypropylene film are manufactured by Plasma Treat LLC of Elgin, Ill. The jets utilized are RD1004 and the nozzles are disposed at a 14 degree angle. The plasma generator is an FG5001, plasma voltage is 300, plasma current is 15.50 and the air pressure is 2.50. The preferred hot melt adhesive used is HB4HL8255PW. Alternatively, Capital Adhesives HM11235S or HM6403PL may be utilized. The polypropylene film is 5 mils in thickness. Similarly, the woven polypropylene film is 25 mils in thickness. Information about using plasma treatment is found in many references including U.S. Pat. No. 7,074,746 and publications from Plasma Treat LLC, which are incorporated by reference. With reference to FIGS. 8, 9, and 13-16, the top outer layer is polypropylene film, preferably biaxial polypropylene, and the woven layer is a blend of 90% polypropylene and 10% polyethylene. The bag or tube-like structure is sealed to the top layer as shown in FIG. 16. Specifically, one wall of the bag is slit and folded as described above. The surfaces to be treated are subjected to a signal pass from the RD1004 Jet then the jet or jets may be positioned as needed, whether on the top of the bag or bottom adhesive, preferably hot melt, was applied in the required areas. The adhesive applicator is not shown. The two treating surfaces were mated with each other and allowed to cool before being trimmed.

Plasma treatment is a method treating a surface of a substrate for further treatment. The plasma treatment involves subjecting a gas such as air or an oxide of nitrogen to an electrical charge and passing it through a jet head under pressure forming a plasma with zero volts that is applied to a substrate. The plasma may condition the substrate for receiving another material. In this instance, the substrate is a polymer, more specifically, a polypropylene polymer. The plasma treatment provides a better surface for sealing the polymer to another surface and enhances the ability of an adhesive to be retained on the polymer treated with the plasma treatment. The plasma treatment provides a secured bonding of the polymer and other materials. The plasma treatment uses only electricity and compressed air and can treat thermally sensitive materials. Thus, the plasma treatment can be readily applied to various areas of a continuous strip or sheet of a polymer that is subsequently formed into a bag. The polymer strip may also be combined with woven polymers, such as woven polypropylene, and other materials, for example, an intermediate or extrusion layer of paper or aluminum sheet and an inner layer of material suitable for contracting the contents of the bag to be formed. The plasma treatment can be used at high speed on flat materials such as a web of polymers for forming bags. Plasma treatment can achieve a desired coefficient of friction in zone 33-33 at a suitable line speed and power. The condition of the zone increases the bonding abilities of the polypropylene films when they contact each other, with the assistance of an adhesive for forming a pinch seal.

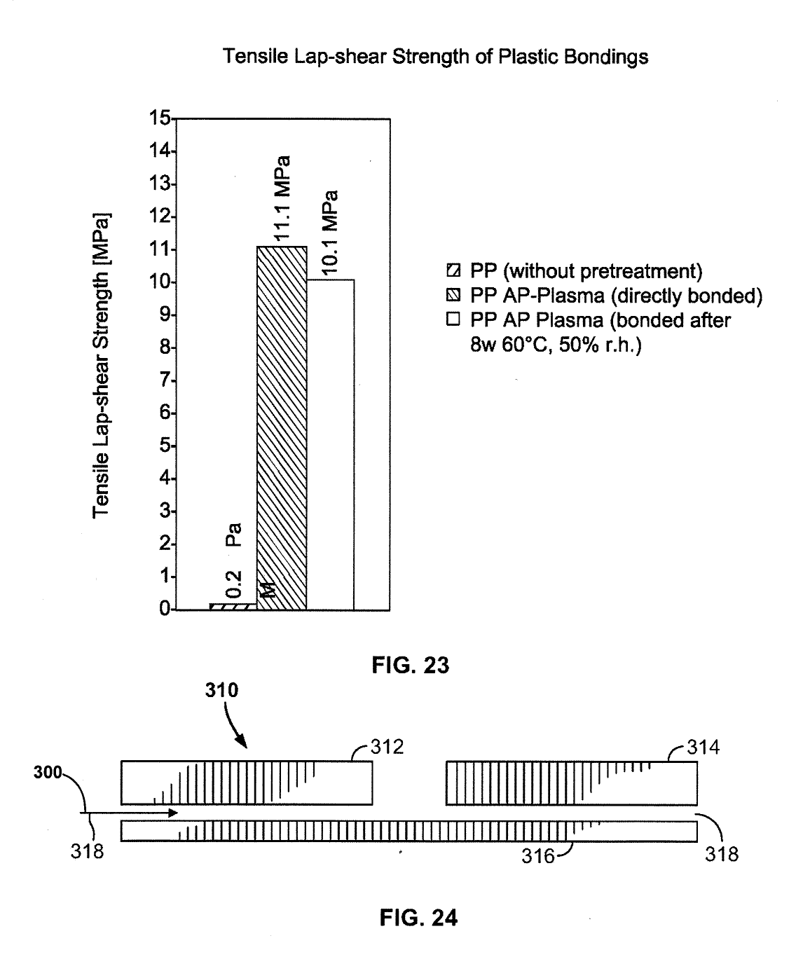

FIG. 23 illustrates a bar graph showing superior results of plastic bonding using plasma treatment versus no plasma treatment for polypropylene in a 2K epoxy system curing at 80 degrees for two hours.

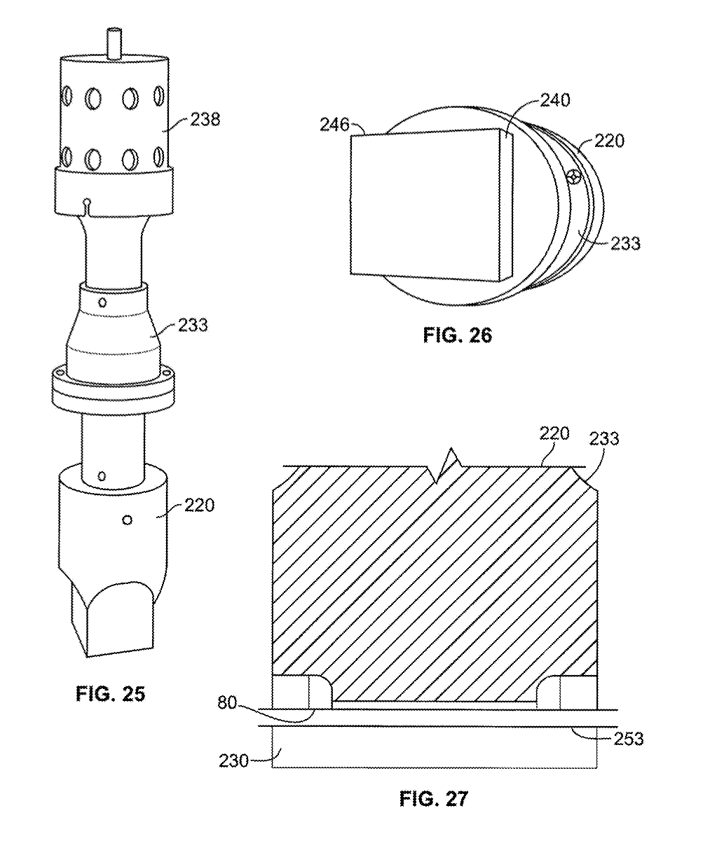

Concerning ultrasonic sealing as depicted in FIGS. 25-26, first matrix 240 is the distal end of horn 233. Alternatively, first matrix 240 can be constructed as a separate die and securely mounted on the distal end of horn 233. It is believed that fashioning first matrix 240 integrally with horn 233, rather than as a separate die mounted on horn 233, tends to promote efficient and reproducible transmission of the vibrations. In either case, first matrix 240 is located at the distal end of horn 233 and can be utilized to press and mold a polymer film, for example, polypropylene while vibrator 220 is vibrating.

Details of first matrix 240 are presented in FIG. 26. First matrix 240 includes a planar face 246 for contacting the surface of the polymer film.

During use, first matrix 240 is placed over film 80 in selected areas 33-33, with moveable anvil (not shown) including a generally planar face 246 for contacting film 80. Alternatively, film 80 may be placed between two vibrators 220 (not shown) for vibrating and pressing between two first matrices 240 (not shown).

FIG. 27 depicts vibrator 220 as it initially impinges on film 80. It is also represented in FIG. 16. At this time, the tension on polypropylene film 80 is carefully controlled by a conventional tensioner. For example, dancer roller assembly is suitable for tensioning film 80. In addition, a tensioning fastener not shown may also be used to control the tension of film 80. Additionally, film 80 may be preheated by means of preheaters (not shown) to a temperature greater than room temperature and less than the melting range or index of the thermoplastic material that composes polypropylene film 80 so as to facilitate molding, and which otherwise allows the saturation heating of film 80 to a prescribed temperature. As pneumatic assemblies not shown apply calibrated force to elevated anvil 230, the pressure that face 246 applies to film 80 and the distance between face 246 and second face (not shown) are carefully controlled. Preferably, face 246 presses upon film 80 with a force of from 10 to 120 pounds per square inch. Preferably, the two faces are not permitted to touch.

Vibrator 220 vibrates a portion of film 33-33 so as to generate internal friction within polypropylene film 80, causing a portion 33-33 of film 80 to become relatively more malleable. The temperature of the vibrated portion often increases during the vibrating. The pressure exerted by first matrix 240 tends to displace some of the malleable portion 33-33 in predictable directions. For example, the depth of transition volumes and thickness of film 80 are calculated to displace a certain amount of the malleable portion, and displace a certain amount of the malleable portion to or from the transition volumes. Twenty kilohertz at 1000 watt power provides vibration at an amplitude of about 45 microns for sealing. The amplitude provides sufficient heat and speed. Barrier 253 is inserted between the layer of the polypropylene and woven polypropylene to be sealed. The barrier prevents heat transfer to the layer opposed to the layer being sealed to the folds of the pinch seal. Barrier 253 is preferably a high-temperature polyimide film made by DuPont. Information about ultrasonic sealing of plastic film is found in “The Handbook of Plastics Joining A Practical Guide” published by the Plastics Design Library, ISBN 1-884207-17-0, which is incorporated by reference.

As described above and shown in the associated drawings, the present invention comprises a method for closing and sealing a tube-formed bag and bags produced thereby. While particular embodiments of the invention have been described, it will be understood, however, that the invention is not limited thereto, since modifications may be made by those skilled in the art, particularly in light of the foregoing teachings. It is, therefore, contemplated by the following claims to cover any such modifications that incorporate those features or those improvements that embody the spirit and scope of the present invention.

What is claimed is:

1. A method of sealing a bag, said bag formed from a tube of material and having a front side and a rear side, and a pair of opposing, inwardly tending gusset folds, each of said folds having front and rear vertical creases, said method comprising the steps of:
slitting each of said front creases along longitudinal axes thereof, thereby obtaining front and rear plies;
forming a first rearward fold by rearwardly folding said rear plies together with said rear vertical creases such that an inner surface of said rear ply is visible; and
forming a second rearward fold by rearwardly folding said first fold wherein said inner surface of said rear ply lays against said rear side of said bag.

2. The method of claim 1, further comprising the step of depositing an adhesive upon said inner surface of said rear ply.

3. The method of claim 2, further comprising the step of depositing said adhesive upon the rear side of said bag where said inner surface lays against it.

4. The method of claim 3, wherein said material is polypropylene.

5. The method of claim 1, wherein said material is polypropylene.

6. The method of claim 5, further comprising the step of depositing an adhesive upon said inner surface of said rear ply.

7. The method of claim 6, further comprising the step of depositing said adhesive upon the rear side of said bag where said inner surface lays against it.

8. The method of claim 1, further comprising forming the first and second rearward fold on the bottom of the bag.

9. The method of claim 1, further comprising applying a binding aid upon said inner surface of said rear ply.

10. The method of claim 1, further comprising the step of applying a binding aid upon the rear side of said bag where said inner surface lays against it.

11. The method of claim 9, further comprising the biding aid is plasma treatment or corona treatment.

12. The method of claim 9, further comprising adhesive is applied onto the inner surface of said rear ply that has been subjected to said binding aid.

13. The method of claim 9, further comprising adhesive is applied onto the rear side of said bag that has been subjected to said binding aid where said inner surface lays against it.

14. The method of claim 1, further comprising a top of the bag is sealed with a reclosable fastener.

15. The method of claim 1, further comprising a reclosable fastener placed on a gusset fold at the top of the bag.

16. The method of claim 1, further comprising using ultrasonic vibration on the inner surface of said rear ply prior to sealing.

17. The method of claim 1, further comprising using ultrasonic vibration on the rear side of said bag when said inner surface lays against it.

18. A flexible bag formed from a tube of material and having a front side and a rear side, and a pair of opposing, inwardly tending gusset folds, each of said folds having front and rear vertical creases, said bag having at least one sealed closure formed by a method comprising the steps of:
slitting each of said front creases along longitudinal axes thereof, thereby obtaining front and rear plies;
forming a first rearward fold by rearwardly folding said rear plies together with said rear vertical creases such that an inner surface of said rear ply is visible; and
forming a second rearward fold by rearwardly folding said first fold wherein said inner surface of said rear ply lays against said rear side of said bag.

19. The bag of claim 18, further comprising forming the first and second rearward fold on the bottom of the bag.

20. The bag of claim 18, further comprising applying a binding aid upon said inner surface of said rear ply.

21. The bag of claim 18, further comprising the step of applying a binding aid upon the rear side of said bag where said inner surface lays against it.

22. The bag of claim 20, further comprising the biding aid is plasma treatment or corona treatment.

23. The bag of claim 20, further comprising adhesive is applied onto the inner surface of said rear ply that has been subjected to said binding aid.

24. The bag of claim 20, further comprising adhesive is applied onto the rear side of said bag that has been subjected to said binding aid where said inner surface lays against it.

25. The bag of claim 18, further comprising a top of the bag is sealed with a reclosable fastener.

26. The bag of claim 18, further comprising a reclosable fastener placed on a gusset fold at the top of the bag.

27. The bag of claim 18, further comprising using ultrasonic vibration on the inner surface of said rear ply prior to sealing.

28. The bag of claim 18, further comprising using ultrasonic vibration on the rear side of said bag when said inner surface lays against it.

29. The bag of claim 18, wherein said method further comprises the step of depositing an adhesive upon said inner surface of said rear ply.

30. The bag of claim 18, wherein said method further comprises the step of depositing said adhesive upon the rear side of said bag where said inner surface lays against it.

31. The bag of claim 18, wherein said material is polypropylene and woven polypropylene.

32. The bag of claim 18, wherein said material is polypropylene and woven polypropylene.

33. The bag of claim 18, wherein said method further comprises the step of depositing an adhesive upon said inner surface of said rear ply.

34. The bag of claim 18, wherein said method further comprises the step of depositing said adhesive upon the rear side of said bag where said inner surface lays against it.

35. A method of sealing a bag, said bag formed from a tube of material and having a front side and a rear side, and a pair of lateral, opposing, inwardly tending gusset folds, each of said folds having front and rear vertical creases, said method comprising the steps of:
parting said material longitudinally along said front crease;
rolling a rear ply resulting from said step of parting along with rear portion of said bag proximal to said rear ply such that a surface of said rear ply opposes the rear side of said bag; and
applying an adhesive element to said surface, said adhesive being for the bonding of said surface with said rear side.

36. The method of claim 35, wherein said step of applying adhesive further comprises applying adhesive to said rear side in the area contacted by said rear ply.

37. The method of claim 35, wherein said material is polypropylene and woven polypropylene.

38. A bag sealed by the method of claim 35.

39. The bag of claim 38, wherein said step of applying adhesive further comprises applying adhesive to said rear side in the area contacted by said rear ply.

40. The bag of claim 38, wherein said material is polypropylene and woven polypropylene.

41. A method of sealing a bag, said bag formed from a tube of material and having a front side and a rear side, and a pair of lateral, opposing, inwardly tending gusset folds, each of said folds having front and rear vertical creases, said method comprising the steps of:
a. treating the surface of said tube of material with a jet of plasma so as to pretreat said surface for sealing;
b. parting said material longitudinally along said front crease;
c. folding a rear ply resulting from said step of parting along with the rear portion of said bag proximate to said rear ply such that said pretreated surface of said rear ply opposes the pretreated surface of the rear side of said bag; and
d. applying an adhesive element to said pretreated surface of said rear ply a compressing said rear portion of said bag, said adhesive and said rear ply are joined, said adhesive being effective to bond said rear portion of said bag to said rear side of bag.

42. A flexible bag comprising:
a tube comprising polypropylene material pretreated at selective areas with plasma treatment, said tube comprising:
a front side;
a rear side;
a pair of opposing, inwardly tending gusset folds, each of said folds having front and rear vertical creases and each of said folds between said front side and said rear side;
at least one sealed closure comprising:
a front ply and a rear ply, said front ply and said rear ply being separated by a pair of slits along said front creases along longitudinal axes thereof, and said rear ply having an outer and inner surface;
a first rearward fold causing said pretreated area of said polypropylene material to form an outer surface of said rear ply which opposes a pretreated second surface of a first portion of the rear side of the bag; and
a second rearward fold causing a pretreated surface of said inner surface of said rear ply to oppose a second pretreated portion of the rear side of the bag.

43. The flexible bag of claim 42, which said adhesive comprises hot melt.

44. The flexible bag of claim 42, wherein the preheated area and pretreated second surface are subjected to binding aids.

45. The flexible bag of claim 44, wherein the binding aid is plasma treatment or corona treatment.

46. The flexible bag of claim 44, wherein the pretreated area and pretreated second surface are subjected to ultrasonic vibrations.

47. A flexible reclosable container comprising a tube of polymer material comprising a front side, a rear side and at least one sealed closure; said container comprising:
selected areas of said polymer material being pretreated with plasma;
a pair of flexible reclosable fastener profiles;
a bead of hot melt adhesive applied to selectively treated surfaces of said polymer material and said reclosable fastener profiles, one of which is attached to the front side of the bag on said selected surfaces with said hot melt being disposed between said selectively treated surfaces and said reclosable fastener profile; and
the other of said flexible reclosable fastener profiles being affixed to said rear side of said bag with said hot melt adhesive being disposed between said second reclosable fastener profile and said rear side;
said fastener profiles each being disposed so as to be selectively interlockable and openable as desired by the user of the bag.

48. A flexible bag comprising:
a tube comprising polypropylene material pretreated at selective areas with plasma treatment, said tube comprising:
a front side;
a rear side;
a pair of opposing, inwardly tending gusset folds, each of said folds having front and rear vertical creases and each of said folds between said front side and said rear side;
at least one sealed closure comprising:
a front ply and a rear ply, said front ply and said rear ply being separated by a pair of slits along said front creases along longitudinal axes thereof, and said rear ply having an outer and inner surface;
a first rearward fold causing said pretreated area of said polypropylene material to form an outer surface of said rear ply which opposes a pretreated second surface of a first portion of the rear side of the bag; and
a second rearward fold causing a pretreated surface of said inner surface of said rear ply to oppose a second pretreated portion of the rear side of the bag.

49. A method of sealing a bag, said method comprising the steps of:
a. treating the surface of said tube of material with a plasma treatment so as to pretreat said surface for sealing;
b. parting said material longitudinally along said front crease;
c. folding a rear ply resulting from said step of parting along with the rear portion of said bag proximate to said rear ply such that said pretreated surface of said rear ply opposes the pretreated surface of the rear side of said bag; and
d. applying an adhesive element to said pretreated surface of said rear ply compressing said rear portion of said bag, said adhesive and said rear ply are joined, said adhesive being effective to bond said rear portion of said bag to said pretreated surface.

50. The flexible bag of claim 49, further comprising the polypropylene material being an outer layer of polypropylene and an inner layer of woven polypropylene.

51. The method of claim 14, further comprising sealing the reclosable fastener to the bag by using ultrasonic sealing.

52. The method of claim 14, further comprising sealing the reclosable fastener by use of a binding aid and an adhesive.

53. The method of claim 25, further comprising sealing the reclosable fastener to the bag by using ultrasonic sealing.

54. The method of claim 25, further comprising sealing the reclosable fastener by use of a binding aid and an adhesive.

55. The flexible bag of claim 42, wherein a reclosable fastener is used to seal a top of the bag.

56. The flexible bag of claim 42, wherein the reclosable fastener is used to seal a top side of the bag.

57. The flexible bag of claim 42, wherein the reclosable fastener is sealed to the top of the bag by ultrasonic sealing.

58. The flexible bag of claim 42, wherein the reclosable fastener is sealed to the top of the bag by the use of a binding aid and an adhesive.
